(19) United States
(12) Patent Application Publication
(10) Pub. No.: US 2010/0163005 A1
(43) Pub. Date: Jul. 1, 2010

(54) HIGH-PRESSURE PUMP FOR DELIVERING FUEL WITH AN IMPROVED DESIGN OF THE BEARING ARRANGEMENT FOR THE SUPPORT OF THE CAM SHAFT

(76) Inventors: Gerhard Meier, Schorndorf (DE); Armin Merz, Weinstadt (DE); Andreas Dutt, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/531,645

(22) PCT Filed: Jan. 25, 2008
(86) PCT No.: PCT/EP2008/050882

§ 371 Date: Feb. 4, 2010

(30) Foreign Application Priority Data
Mar. 16, 2007 (DE) 10 2007 012 704.0

(51) Int. Cl. F02M 37/04; F04B 9/14; F16C 9/00

(52) U.S. Cl. 123/495; 417/374; 384/457

(57) ABSTRACT

The present invention relates to a high-pressure pump, particularly for delivering fuel for a common rail fuel injection system, having a pump body in which at least one cam drive having a cam shaft is received. The cam shaft is pivotally supported about a cam shaft axis in the pump body and/or in a flange body by at least one bearing arrangement. The bearing arrangement includes a radial bearing bush extending in the direction of the cam shaft axis, and an axial bearing washer, which is integrally formed on the radial bearing bush. The axial bearing washer extends in a radial extension direction of less than 90 degrees relative to the cam shaft axis in the non-installed state. The radial extension direction is directed toward the radial bearing bush and can be brought into an axial bearing plane extending at an angle of 90 degrees to the cam shaft axis in the installed state by elastic deformation of the axial bearing washer.

The present invention relates to a high-pressure pump for delivering fuel for a common rail fuel injection system of the type defined in greater detail in the preamble to the claim.

### PRIOR ART

High-pressure pumps for delivering fuel of the type of interest here are preferably embodied with a cam mechanism; a camshaft is supported in rotary fashion in the pump body and in a flange body mounted in the pump body. During operation of the high-pressure pump, the camshaft rotates around a camshaft axis and sets a cam follower device into a stroke motion, which cooperates with a valve unit to deliver the fuel. Due to the high operating pressures of a common rail fuel injection system, powerful forces are exerted on the camshaft via the cam mechanism, which are absorbed by a slide bearing situated on the left and right sides of the cam mechanism. The slide bearings include a radial bearing bush for absorbing radial forces; an axial bearing washer is provided, which absorbs the forces in the direction of the camshaft axis. Either the camshaft is supported with an axial bearing washer in both directions of the camshaft axis; an arrangement can be provided with a single axial bearing. In the latter case, the radial bearing bush and the axial bearing washer are embodied as a single component; depending on the structural embodiment, the axial bearing washer and the radial bearing bush can be of one piece with each other and made of the same material as each other or the axial bearing washer is attached to one end of the radial bearing bush. The axial bearing washer can be integrally joined to the radial bearing bush or can be can be attached to it in a form-locked manner; preferably, a welded connection is used.

It should be noted that the prior art also includes high-pressure pumps in which the axial bearing washer and radial bearing bush are installed separately from each other in the housing. The axial bearing washer is fixed in position by means of split pins; this requires additional components and additional assembly procedures, which is why a single unit composed of an axial bearing washer and radial bearing bush is preferable.

With such bearings supporting the camshaft in a high-pressure pump, the problem arises that the flat contact of the axial bearing washer against the flat contact surface in the pump body is not assured since elastic deformations of the axial bearing washer cannot be maintained in the presence of a significant axial load of the axial bearing of the camshaft. As a result, a very powerful load on the welding seam between the axial bearing washer and the radial bearing bush can occur, which may cause it to fail. A fracture in the welding seam between the axial bearing washer and the radial bearing bush causes a failure of the high-pressure pump. A fracture of the welding seam particularly occurs when the axial bearing washer does not rest flush against the flat contact surface in the pump body so that in the event of undesirable loads, stress concentrations and maximum surface pressures occur between the axial bearing washer and the flat contact surface, which cause an overload and therefore a fracture of the welding seam.

The object of the invention, therefore, is to create a high-pressure pump for delivering fuel, which has an improved bearing arrangement for supporting the camshaft inside the pump body.

This object is attained based on a high-pressure pump for delivering fuel as recited in the preamble to claim 1 in connection with its defining characteristics. Advantageous modifications of the invention are disclosed in the dependent claims.

The invention includes the technical teaching that in the non-installed state, the axial bearing washer extends in a radial extension direction of <90° relative to the camshaft axis, with the radial extension direction pointing toward the radial bearing bush, and in the installed state, can be brought into an axial bearing plane extending at 90° relative to the camshaft axis by means of an elastic deformation of the axial bearing washer.

The invention is based on the concept that through the geometric embodiment according to the invention, in the installed state, the axial bearing washer produces a state of stress in the region of the welding seam in which no fracturing of the welding seam occurs. Through the selective positioning of the axial bearing washer, it is possible, after the assembly of the unit composed of the axial bearing washer and the radial bearing bush, to assure that the axial bearing washer rests securely against the flat contact surface on the pump body, avoiding a fracture of the welding seam. The deformation of the axial bearing washer from the radial extension direction of <90° into the plane of the axial bearing plane is achieved by means of an elastic deformation. In this instance, the axial bearing washer is made to rest flat against the flat contact surface both on the radial inside and on the radial outside merely by means of its spring action.

The pump body advantageously has a flat contact surface, which is brought to the required degree of precision by a material-removing machining procedure so that the axial bearing washer can rest flat against it in the installed state.

The radial extension direction of the axial bearing washer in the non-installed state advantageously encloses an angle of from 80°-89.99° and preferably from 86°-89.9° relative to the camshaft axis. It is preferable to select an angle close to 90° in order to minimize the stress on the welding seam due to the elastic bending of the axial bearing washer in the installed state. An angle of 89° is particularly advantageous; the angle also depends on the thickness of the axial bearing washer. The radial bearing bush and the axial bearing washer have a multi-component embodiment so that a steel casing constitutes the basic form of the bearing bush or axial bearing washer and a PEEK material or a carbon fiber-reinforced material is provided in the steel casing as the sliding surface in order to produce the slide bearing. The elastic bending of the axial bearing washer, however, is limited to the steel jacket; the welding seam joins the respective steel components of the axial bearing washer and the radial bearing bush. It can therefore be assumed that with a thicker embodiment of the steel component, an almost right angle is preferable; with a thinner embodiment of the steel component, a larger deviation from a right angle can be provided since the bending forces that occur are also weaker due to the lower rigidity.

For structural reasons, it is particularly advantageous for the radial bearing bush to be press-fitted into a bearing bore provided in the pump body and/or in the flange body. For assembly reasons, a flange body is provided, which likewise accommodates the bearing of the camshaft. Consequently, one bearing is situated in the pump body itself and another bearing is situated in the flange body. In the assembly of the high-pressure pump, first one bearing is press-fitted into the pump body so that the camshaft can then be fitted into the bearing. Then a second bearing can be press-fitted into the flange body, which is then inserted into the pump body and screw-connected to it. This consequently achieves a bearing arrangement of the camshaft that can be assembled and disassembled, with a first bearing provided in the pump body and a second bearing provided in the flange body. The press-fitting of the radial bearing bush into the corresponding bore in the pump body and in the flange body offers a particularly simple attachment option; care must be taken that the force used to press-fit the radial bearing bush into the bearing bore is sufficiently powerful to overcome the spring force in the axial bearing washer and assure a hold of the axial bearing washer against the flat contact surface so that the spring action of the axial bearing washer does not cause the radial bearing bush to automatically back out of the bearing bore. Other attachment options, however, are also possible so that it is also possible for a clearance fit to be provided between the radial bearing bush and the bearing bore and for the axial fixing of the radial bearing bush and/or the axial bearing washer to be produced by means of additional elements.

The surface pressure between the axial bearing washer and the flat contact surface is advantageously distributed uniformly over the radial breadth of the axial bearing washer. In this case, the angle between the camshaft axis and the extension direction of the axial bearing washer can be selected so that there is a uniform surface pressure from the inside of the axial bearing washer to the radial outside. The bending moment over the radius of the axial bearing washer thus decreases uniformly toward the outside so that a flat axial bearing plane is produced in the installed state.

It is also advantageous that the transition between the flat contact surface and the bearing bore in the pump body includes a bevel. The formation of the bevel can naturally also be provided in the flange body so that in the hollow between the axial bearing washer and the radial bearing bush, the welding seam can take up a corresponding amount of space so that the bevel leaves this room unobstructed. In addition, the surface pressure between the flat contact surface and the axial bearing washer does not begin immediately at the radial inside of the axial bearing washer, but only after the end of the phase in the radial direction. This produces an advantageous geometric embodiment and an improved introduction of stress into the welding seam.

The uniform stress distribution also applies to the surface pressure between the axial bearing washer and the flat stop of the camshaft so that here, too, there is an advantageously uniform distribution of the surface pressure over the radial breadth of the axial bearing washer. This also reduces the strain on the welding seam between the axial bearing washer and the radial bearing bush.

Other measures that improve the invention will be illustrated in greater detail below, together with the description of a preferred exemplary embodiment of the invention in conjunction with the figures.

### EXEMPLARY EMBODIMENT

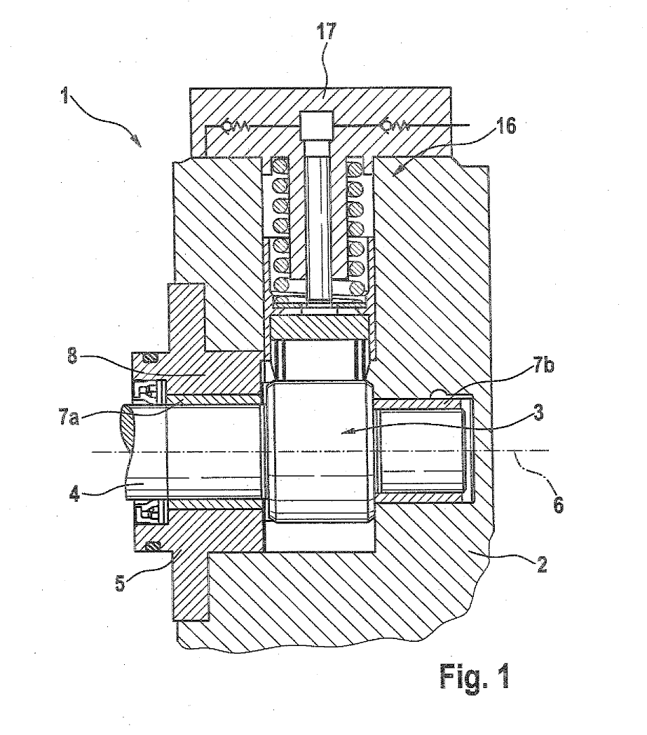

FIG. 1 is a cross-sectional side view of a high-pressure pump with a camshaft, which is supported in rotary fashion inside the pump body by means of a radial bearing bush on the left and on the right and at least one axial bearing bush.

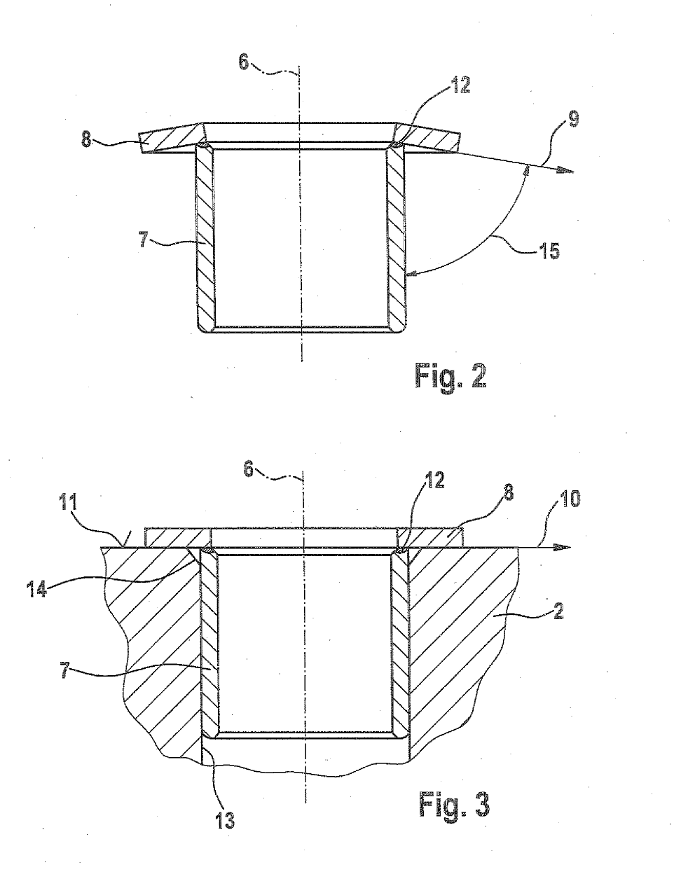

FIG. 2 is a cross-sectional view of a unit composed of a radial bearing bush and an axial bearing washer welded to it, in the non-installed state; and

FIG. 3 shows the unit composed of the radial bearing bush and axial bearing washer in an installed state in the pump body.

The high-pressure pump 1 shown in FIG. 1 includes a pump body 2 in which a camshaft 4 is supported so that it is able to rotate around a camshaft axis 6. The camshaft 4 includes a cam mechanism 3, which sets a cam follower unit 16 into a reciprocating motion so that the latter can cooperate with a valve unit 17 in order to produce a delivery of the fuel. The camshaft 4 is supported by means of two bearing arrangements so that a first radial bearing bush 7a situated to the left of the cam mechanism is installed inside a flange body 5 and a second radial bearing bush 7b is installed on the right side, inside the pump body 2 itself. There is thus a radial bearing to both the left and right of the cam mechanism 3, with an axial bearing washer 8 provided on the left side, which is welded to the radial bearing bush 7a. The axial bearing washer 8 serves to absorb forces acting axially in the direction of the camshaft axis 6, which are introduced into the camshaft 4 either externally or by the cam mechanism. The axial bearing washer 8 rests against the flange body 5, with the radial bearing bush 7 and the axial bearing washer 8 being press-fitted into the flange body 5. The radial bearing bush 7b is also press-fitted into the pump body 2 so that the respective radial bearing bushes 7a and 7b are fixed in place axially.

FIG. 2 shows a view of a bearing unit in a non-installed state; the unit includes at least one radial bearing bush 7 and one axial bearing washer 8. The axial bearing washer 8 is connected to the radial bearing bush 7 by means of a circumferential welding seam 12. According to the invention, the axial bearing washer has a radial extension direction 9 that assumes a value <90° in relation to the camshaft axis 6. The position of the axial bearing washer 8 is uniform around the circumference so that independent of the circumference direction, the radial extension direction 9 assumes the same angle <90° in relation to the camshaft axis 6. The axial bearing washer 8 is connected to the radial bearing bush 7 by means of the welding seam 12; the welding seam 12 is also provided on the entire circumference of the bearing arrangement.

FIG. 3 shows the bearing arrangement according to FIG. 2 in an installed state in the pump body 2. For installation, the radial bearing bush 7 is press-fitted into the bearing bore 13 so that the axial bearing washer 8 rests flat against the flat contact surface 11 in the pump body 2. This produces an elastic deformation of the axial bearing washer 8 so that the latter rests flat against the flat contact surface 11 over its entire radius from the inside to the radial outside. This takes the strain off the welding seam 12 so that no undesirable stress concentrations occur in the welding seam, thus avoiding a fracture of the welding seam. The transition from the flat contact surface 11 to the bearing bore 13 has a bevel 14 so that the start of the flat contact of the axial bearing washer 8 against the flat contact surface 11 first begins at a radius that is greater than the radius of the bearing bore 13. The arrangement according to the invention assures that the axial bearing washer 8 as a whole offers a flat stop surface for the camshaft in order to achieve a uniform distribution of surface pressure between the camshaft and the axial bearing washer 8 as well as between the axial bearing washer 8 and the flat contact surface 11 in the pump body 2.

The embodiment of the invention is not limited to the preferred exemplary embodiment given above. There are instead a number of conceivable variants that make use of the approach mentioned above, even in embodiments that differ from it categorically in nature.

1-8. (canceled)

9. A high-pressure pump, in particular for delivering fuel for a common rail fuel injection system, comprising:
a pump body;
at least one cam mechanism with a camshaft, accommodated in the pump body;
at least one bearing arrangement in the pump body and/or in a flange body, supporting the camshaft so that the camshaft is rotatable around a camshaft axis; and
a radial bearing bush of the bearing arrangement extends in the direction of the camshaft axis, and an axial bearing washer of the bearing arrangement formed onto or attached to one end of the radial bearing bush, wherein
in a non-installed state, the axial bearing washer extends in a radial extension direction of less than 90° relative to the camshaft axis, with the radial extension direction (9) pointing toward the radial bearing bush, and in an installed state, it is possible by means of an elastic deformation of the axial bearing washer to move it into an axial bearing plane extending at 90° relative to the camshaft axis.

10. The high-pressure pump as recited in claim 9, wherein the pump body has a flat contact surface against which the axial bearing washer is brought into flat contact in the installed state.

11. The high-pressure pump as recited in claim 9, wherein in the non-installed state, the radial extension direction of the axial bearing washer encloses an angle relative to the camshaft axis of from 80° to 89.99° and preferably from 86° to 89.9°.

12. The high-pressure pump as recited in claim 10, wherein in the non-installed state, the radial extension direction of the axial bearing washer encloses an angle relative to the camshaft axis of from 80° to 89.99° and preferably from 86° to 89.9°.

13. The high-pressure pump as recited in claim 9, wherein the axial bearing washer is welded to the radial bearing bush by means of a welding seam.

14. The high-pressure pump as recited in claim 10, wherein the axial bearing washer is welded to the radial bearing bush by means of a welding seam.

15. The high-pressure pump as recited in claim 11, wherein the axial bearing washer is welded to the radial bearing bush by means of a welding seam.

16. The high-pressure pump as recited in claim 12, wherein the axial bearing washer is welded to the radial bearing bush by means of a welding seam.

17. The high-pressure pump as recited in claim 9, wherein the radial bearing bush is press-fitted into a bearing bore provided in the pump body and/or in the flange body.

18. The high-pressure pump as recited in claim 10, wherein the radial bearing bush is press-fitted into a bearing bore provided in the pump body and/or in the flange body.

19. The high-pressure pump as recited in claim 11, wherein the radial bearing bush is press-fitted into a bearing bore provided in the pump body and/or in the flange body.

20. The high-pressure pump as recited in claim 12, wherein the radial bearing bush is press-fitted into a bearing bore provided in the pump body and/or in the flange body.

21. The high-pressure pump as recited in claim 13, wherein the radial bearing bush is press-fitted into a bearing bore provided in the pump body and/or in the flange body.

22. The high-pressure pump as recited in claim 16, wherein the radial bearing bush is press-fitted into a bearing bore provided in the pump body and/or in the flange body.

23. The high-pressure pump as recited in claim 10, wherein the surface pressure between the axial bearing washer and the flat contact surface is distributed uniformly over the radial width of the axial bearing washer.

24. The high-pressure pump as recited in claim 18, wherein the transition between the flat contact surface and the bearing bore in the pump body has a bevel.

25. The high-pressure pump as recited in claim 13, wherein at a flat stop of the camshaft, between the camshaft and the axial bearing washer, there is a surface pressure that is uniform over a radial span of the axial bearing washer in order to relieve stress on the welding seam.

26. The high-pressure pump as recited in claim 14, wherein at a flat stop of the camshaft, between the camshaft and the axial bearing washer, there is a surface pressure that is uniform over a radial span of the axial bearing washer in order to relieve stress on the welding seam.

27. The high-pressure pump as recited in claim 15, wherein at a flat stop of the camshaft, between the camshaft and the axial bearing washer, there is a surface pressure that is uniform over a radial span of the axial bearing washer in order to relieve stress on the welding seam.

28. The high-pressure pump as recited in claim 16, wherein at a flat stop of the camshaft, between the camshaft and the axial bearing washer, there is a surface pressure that is uniform over a radial span of the axial bearing washer in order to relieve stress on the welding seam.
